(19) United States
(12) Patent Application Publication
(10) Pub. No.: US 2011/0155269 A1
(43) Pub. Date: Jun. 30, 2011

(54) RETROFIT SUSTAINABLE DEVICE FOR WATER CONSERVATION

(76) Inventor: Scott Martin, Mission Viejo, CA (US)

(21) Appl. No.: 12/983,289

(22) Filed: Dec. 31, 2010

Related U.S. Application Data
(60) Provisional application No. 61/291,810, filed on Dec. 31, 2009.

(51) Int. Cl. F16K 37/00

(52) U.S. Cl. 137/552.7

(57) ABSTRACT

The instant invention will conserve water and energy by monitoring and limiting water usage in both commercial and residential settings. The device employs a mechanical timer and plate valve to control the amount of time water is running and to notify the user that, after a set amount of time has elapsed, the water will shut off. The device can be easily retrofit for use in commercial and residential buildings, and sea going vessels, as well as applied to commercial kitchens and outdoor commercial and residential landscape. The user is restricted to a fixed maximum duration of water. After a preset time has elapsed, the water flow will stop. This water conservation invention has wide application in commercial and residential settings as a means to pride consumers with an effective, easy and inexpensive way to save hundreds of thousands of gallons of water from being wasted monthly.

### CROSS-REFERENCE TO RELATED APPLICATIONS

This patent application claims the benefit of U.S. Provisional Patent Application of Ser. No. 61/291,810, entitled Shower Water Conservation Device, filed 31 Dec. 2009 by the instant inventor.

### FIELD OF THE INVENTION

The present invention relates generally to water timers used to control valves for the shut off of water flow at preset times for use in commercial and residential kitchen and bath water systems.

### BACKGROUND OF THE INVENTION

With the growing awareness of the need to protect environmental resources, federal. state, and local government authorities have imposed stricter and stricter water conservation requirements on communities. Water conservation measures have been practiced for decades, but the education of the general populace to the need to avoid wasting fresh water and the assertive application of conservation measures continues to lag. The need for assertive application has increased with exploding population rates, fluctuations in climate, and development of geographical areas that once were considered unpopulated deserts. The result is that the quantity of freshwater, a precious natural resource, is becoming scarce at an alarming rate.

Water conservation measures can be applied by industry, municipality, and individual users. Such measures may take the form of recycling, systems designed for controlling quality and quantity of use, monitoring systems, and temperature and water saturation sensor systems, leak detection systems, and safety shut-off systems. Yet, these systems fail to address the issue of educating water consumers on the need to assertively save water.

In both commercial and private settings, the most blatant waste of water, and therefore the areas where conservation will make a significant difference, is in kitchen and bath usage. People and businesses often have no idea of the amount of water that is wasted on a daily basis while showers or faucets are left running without being monitored. In commercial kitchens, water faucets may be left running for 12 to 16 hours a day while dishes are being washed or vegetables are being prepared for meals. Often, business travelers employ the common practice to leave a suit hanging in a bathroom with the water running for 15 or 20 minutes.

Showering is the most common form of bathing because they are an efficient use of time, not because they are an efficient use of water. Studies have shown that an individual generally has little awareness of the duration of time spent in a shower and is oblivious to the overall water usage. Five minute showers can extend to thirty minutes or more when people apply various cosmetics and creams, use dye or other hair treatments, and shave with the water running.

When numbers are applied, the amount of water used yearly takes on enormous proportions. For example, in a 100 room hotel, with maximum occupancy assuming half the rooms are single occupant and half are double occupant (150 occupants), and assuming that each guest showers just once a day for 20 minutes, each shower consumes 4 gallons of water a minute equaling 80 gallons per shower, the water usage would be 12,000 gallons daily just for showers. If the hotel has full occupancy for two thirds of the year (225 days), with daily shower water usage of 12,000 gallons daily, the result is 2.7 million gallons of water used annually for showers at that one single hotel.

There are more than 12,200 hotel rooms in Las Vegas. If all hotel rooms in Las Vegas were occupied on a single day, again assuming half single and half double occupancy with each guest showering for 20 minutes, daily shower water consumption would be more than 1.46 million gallons. With a retrofit water conservation device, the amount of shower water consumed could be reduced by 25% daily.

The numbers in the previous example cover only shower usage. They don't include water running from commercial faucets, outdoor pool showers, water fountains and features, kitchens, and public showers. Also, the water usage numbers do not include energy consumption. Hotels over six stories high require power driven pumps to force water to the shower heads, kitchen faucets, and other destinations, consuming tremendous quantities of energy. If less water is used, energy is saved because the pumps will run less frequently.

Further, conservation of water will actually conserve energy on cruise ships. With less water being used, many ships s consume less energy, as the power driven pumps that force water around the ship need not run. On cruise ships, tremendous amounts of energy are consumed running the ship desalination pumps. If less water is used on board the ship in commercial kitchens and in hotel rooms, the desalination pumps need to be run less frequently.

### DESCRIPTION OF PRIOR ART

There is no prior art that is known to anticipate the current invention.

One piece of relevant prior art is found at U.S. Pat. No. 4,936,508 to inventor Ingalz, issued on Jun. 26, 1990. This is also for a metering device on a shower head. However, it does not operate through a visual meter, but rather via an audible alarm, when a pre-set volume of liquid has passed through the showerhead. This invention does not limit the water supply to a shower.

More relevant prior art is found at U.S. Pat. No. 6,734,806 issued to inventor Cratzley, III on May 11, 2004. This invention is quite a bit different in that the metering information is not available to the shower user, but is instead routed to a computer. The inventor suggests a color-coded metering on the computer display, with different colors indicated different amounts of water usage.

Also relevant is the invention found at U.S. Pat. No. 7,229,031, issued to inventor Schmidt on Jun. 12, 2007. This invention is therein described as a showerhead with an internal valve to control the flow of water between a full flow and reduced flow condition so as to save energy and thereby conserve the supply of water. The invention does not limit the time of water usage, nor does it allow user control of the water supply.

Not surprisingly, much of the prior art deals with monitoring rather than controlling water usage. Typically, a monitoring station is used in an industrial or agricultural setting. It can be used to monitor time of water usage, to detect leakage, or other purposes related to water conservation. Water monitoring is also used commonly by municipal utilities to bill customers according to degree of consumption of water. An example of this type of invention is found at U.S. Pat. No. 6,944,523, issued to Addink & Addink on Sep. 13, 2005, for a device capable of monitoring, recording and processing utility commodity usage.

Conventional water timer systems are available for usage in garden sprinkler systems. Said systems require user programming using hardware inputs like switches and knobs, display touch screen inputs, or a combination of these inputs. Examples include the programmable water timer taught in Simon, U.S. Patent No. 20060217845, issued Sep. 28, 2006, and the soil moisture sensor and timer shown in Nies, Patent No. 20080255708, issued Oct. 16, 2008. These systems are generally two complex, making them expensive to produce and purchase, and are not available for installation in bathroom or kitchen plumbing systems.

Water valves have been developed for specific detection applications such as devices for the detection of water pressure taught in Roffey, U.S. Patent No. 20070074767, issued Apr. 5, 2007; detection of leaks as protected in Burlage, and Burlage, U.S. Patent No. 20080087330, issued Apr. 17, 2008; and Brown, U.S. Patent No. 20080283129, issued Nov. 20, 2008; and detection of temperature as shown in Boey. U.S. Patent No. 20080163942, issued Jul. 10, 2008. The additional complexity of said valve systems is not required when the purpose of the device is to merely shut off the water flow, as is accomplished by the present invention.

Prior art also teaches faucet systems that monitor water usage, using a meter to show energy consumption as the water runs. As an example, see Dayton, Patent No. 20080262755, which calculates the flow of water from a faucet and displays water usage. Unlike the present invention, these monitoring systems do not shut off the water, but merely attempt to alert the user of the quantity of water used.

There are also faucet water flow control systems that can be activated by pressure or infrared sensing devices that stop the flow after a few minutes of time when the heat or pressure is removed, as shown in Boey, U.S. Patent No. 20080163942, issued Jul. 10, 2008. The timers in these systems are cannot be set for lengthy time periods and do not account for the higher water pressure in kitchen and shower plumbing systems.

### BRIEF DESCRIPTION OF THE INVENTION

The present invention is a retrofit water conservation device that saves water by limiting the time water is supplied to the end user. The retrofit water conservation device incorporates a gear-driven timer mechanism, connected to an actuator arm that is itself attached to a water shutoff plug. The geared mechanism is set by manually adjusting a dial to the desired time of use. This maximum time of use may be adjusted in the manufacturing process to accommodate the individual needs of commercial and residential clients. A visual analog is clearly marked on the timer mechanism, and when the allotted time is complete, the gears will have maneuvered the plug to a position where it closes the water pipe running to the end user, thus turning off the flow of water. This retrofit water conservation device is to be used between any commercial or residential shower head or kitchen faucet, and the pipe from the wall or faucet itself, either inside or outside the facility.

A feature of embodiments of the current invention is that the gear and spring technology of the current invention is ingenious, and yet can be easily and cheaply manufactured.

Another feature of embodiments of the current invention is that it is can be manufactured to support water at higher pressure for use in high-rise and cruise ship systems.

Another feature of embodiments of the present invention is that they can be easily attached to existing piping into kitchen and bath faucet systems in commercial and residential structures.

Other applications not herein described will become obvious from inspection of the detailed description of the invention below, and of the appended drawings.

### BRIEF DESCRIPTIONS OF THE DRAWINGS

FIG. 1 displays a preferred embodiment of the water conservation mechanism of the current invention from a frontal perspective view. This view shows the user-adjustable dial to set the time of water flow.

FIG. 2 is a cutaway frontal plan view of a preferred embodiment of the water conservation mechanism of the current invention, displaying the gearing action therein.

FIG. 3 is a further cutaway perspective view a preferred embodiment of the current invention, displaying the gearing mechanism and the actuator arm leading to the water shutoff plug valve.

FIG. 4 is a cutaway view of the gearing and shutoff valve displayed in FIG. 3.

FIG. 5 is a side cutaway view of the gearing and shutoff valve displayed in FIG. 3.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner, for residential and for commercial use.

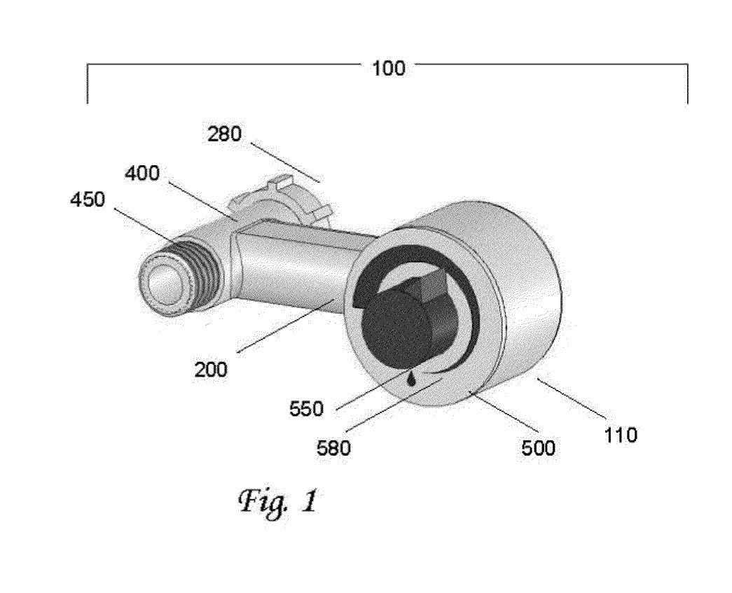

FIG. 1 displays a preferred embodiment of the water control mechanism of the current invention 100 from a frontal perspective view. The front plate 500 of the housing 110 forms a dial, while the hand-cranked knob 550 acts as an indicator of water flow time remaining. The farther around the dial the knob is cranked, the longer the water flow will last. Preferably, the mechanism will create a limit to the maximum time allowed of water flow. In practice, the timer works off a spring mechanism. The farther the knob is cranked, the longer the spring will take to uncoil by transferring its energy to the gears.

It will be noted that many embodiments of the current invention will be optimized for the control of water as a water. To that end, the use of embodiments of the current invention for water control will be emphasized in this description. However, it should be note that embodiments of the current invention are contemplated for the transfer of controllable water flow of waters other than water, as well as the flow of water itself. Such waters may include other liquids, of a flammable or inflammable nature. Such waters may even include gases. The particular embodiments of the current invention employed in these uses will include other details, such as materials impervious to gas leaks, non-sparking materials, exclusion of air, and in some instances the ability to operate under high pressure. Such improvements are known in the art, and can be readily adapted to use within the current invention as contemplated.

The water control mechanism of the current invention acts as a timing device. After cranking, the user will experience water flow as normal. The mechanism winds the knob 550 down until it reaches the zero point, the water drop indicator 580. At that point, the water flow is cut off, and the water dispensing mechanism ceases to function.

The user is free to reset the knob 550, to continue a water flow, in one preferred embodiment of the current invention. In another preferred embodiment, a delay time is built into the mechanism. The water flow, once cut off by passage of time, cannot be re-activated until the time delay has elapsed. The user preferably cannot reset the knob 550 until the delay time has elapsed.

The mechanism operates independently of the normal hot and cold water controls on a faucet or shower. Therefore, a user can set the current invention water control mechanism 100 as described above, and terminate his water flow prior to the mechanism reaching the zero point at 580. In other words, the timer has reached the end of the preset time, thereby resulting in the cutoff of the water supply. Thus, a user can independently shut off the water flow while the current invention is still operating. However, in a preferred embodiment of the current invention, the water flow cannot be started until the current invention has been enabled by cranking knob 550. The invention operates in this fashion because the water supply is intercepted before it reaches the normal water controls of the water flow. This is to encourage users to employ the current invention, and not to simply ignore it, and thus forego its conservation benefits.

Also shown in FIG. 1, for an embodiment of the current invention employed in a conventional shower, is chamber 200, comprising conduit pipe which enables the water shutoff mechanism to operate; water pipe 400, which carries water from the plumbing supply to the shower head or faucet; male pipe thread 450, which connects to the shower head or other end use device (not shown); and female pipe connector 280, for connection of the current invention to the supply source which delivers water.

Installing the current invention is straightforward. The invention is designed to be factory installed, in one embodiment, or retrofit in a second embodiment. The retrofit design is preferably configured to be easily installed in commercial or residential use, without the need, for professional installation. In one embodiment, the homeowner or occupant will unscrew the shower head from its mounting on the water pipe, and in its place connect the current invention 100 via mounting connector 280. The shower head is then reconnected by means of attachment to male pipe thread 450.

As the device is installed in the shower, or in other water-transporting uses, in most preferred embodiments, the chamber 200 is watertight, both to prevent water from leaking to the outside, and also to avoid leakage into the internal gear-driven timer mechanism within housing 110. A seal will isolate water in chamber 200 from housing 110.

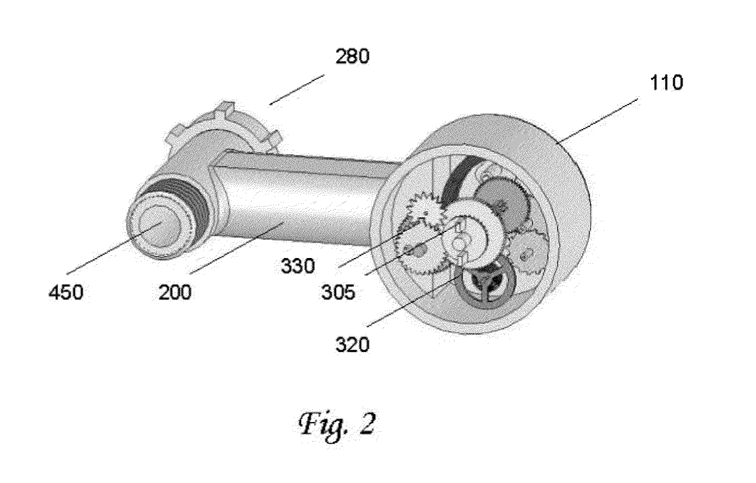

FIG. 2 is a cutaway view of the water control mechanism, from the same viewpoint as in FIG. 1. Here, the front plate 500 within housing 110, containing the dial and control knob 550, has been removed in order to show the internal workings of the timer mechanism 300 of the current invention. At the top of the timer mechanism 300 is found connector 305. Connector 305 simply translates the position of knob 550 to the working elements of timer mechanism 300. The working elements comprise flywheel 320, gears 330, and springs (not shown in this view). Working in concert, the working elements supply the driving force and control for the shutoff actuator (also not shown in this view).

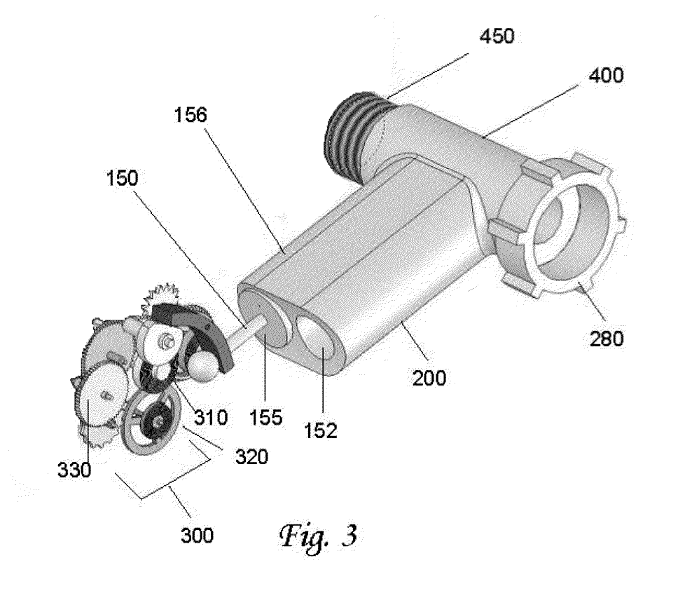

FIG. 3 shows the water control mechanism of the current invention, from a different viewpoint as seen in the prior Figures. Here, the entire housing 110, including front plate 500 and control knob 550, have been removed for viewing of more details of the internal workings of the timer mechanism 300 of the current invention. Newly revealed in the internal elements are springs 310. These springs are wound by the timer, and serve to actuate the gearing of the water control mechanism. Also seen in this view is the actuator arm 150, which terminates in slidable plate valve 155. When activated, the timer mechanism 300 acts to advance the actuator arm 150, eventually at the end of the timed period placing plate valve 155 in position to completely block the interior of chamber 200, thereby stopping the flow of water to the outlet, such as a shower head.

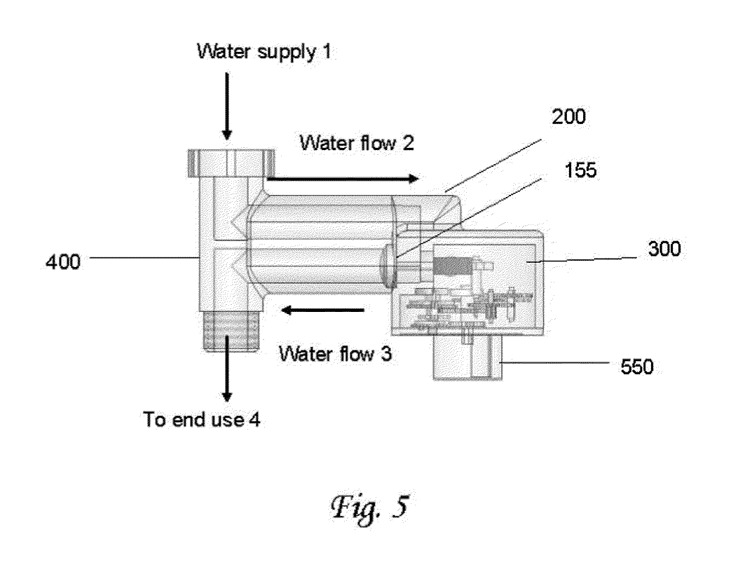

Although not fully displayed in FIG. 3, chamber 200 is comprised of three channels for conducting the flow of water. Water flows in from the water supply via pipe connector 280 to water pipe 400. Though not displayed, water conduit 400 is blocked at a point approximately midway between pipe connector 280 and male pipe thread 450. (See FIG. 5.) Therefore the water flow cannot proceed completely through conduit 400, but is instead diverted to flow through channel 152 inside chamber 200, through an intermediate link (not displayed), and through to channel 156. As seen in FIG. 3, the timer has run out of time, and caused the water flow to be blocked at the entry to channel 156 by the sliding plate valve 155 to the indicated position. In contrast, when the timer is first set, the plate valve 155 is slidably moved back towards the gears in housing 110, such that it (the plate valve) no longer blocks channel 156. Therefore water is free to flow inside chamber 200, in the direction from the supply side of water conduit 400 through channel 152, thence through channel 156, and to the outlet side of conduit 400, and out to the end use device (such as a faucet or shower head).

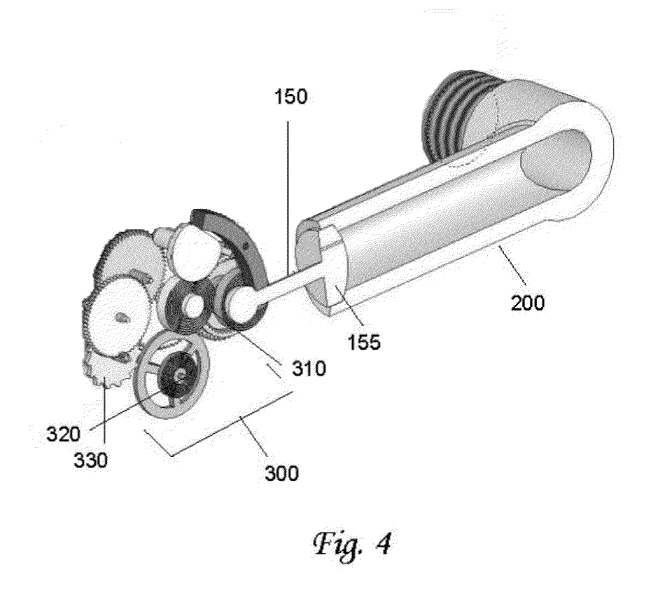

FIG. 4 displays a retrofit embodiment of the water control mechanism of the current invention, from a similar viewpoint as seen in FIG. 3. In this Figure, chamber 200 is shown in cutaway view to demonstrate the travel of actuator arm 150 and plate valve 155 through the water channel. Shown in this view are the detail and elements of timer mechanism 300 of the current invention, including coiled springs 310, flywheel 320, and gears 330.

Moving to FIG. 5, we see a complete embodiment of the current invention in assembly, with transparent walls to facilitate the view of the internal mechanism. In the embodiment depicted in this figure, water from water supply 1 enters the top left of the device at mounting connector 280. As shown, the water flows down through pipe 400, and then is routed to the right into the upper channel of pipe 200, per the arrow of Water flow 2. Water flows to the right end of the upper channel 152 of chamber 200, then down and to the left of the lower channel 156 of chamber 200, per the arrow of Water flow 3. At the end of the lower channel 156, the water is routed down through pipe 400, per the arrow 4, and to the end use.

In the actual position shown in FIG. 5, the timer mechanism 300 has advanced actuator arm 150 and plate valve 155 to the point where the plate valve has completely blocked the lower water channel 156 of chamber 200. Thus, Water flow 3 and 4 to the end use location has ceased, and the watering period is over. Indicator knob 550, seen at the lower right, will be at the zero position, although the dial 500 is not visible in this view.

The process for operation of the present invention is simple. In one preferred embodiment of the current invention, the user or operator prepares for the watering process, and then turns the operational knob 550 to the desired position for length of time for water flow. (This becomes more apparent with experience of use.) The user then can operate the normal water controls, which in many embodiments preferably can be operated independently of the water control mechanism of the current invention. From this point, operation of the shower is as in a routine process for using water flow.

If for some reason the user is unprepared for the watering process to end when the water flow stops, the situation is easily retrievable. Assuming no built-in delay, the user merely repeats the process of turning the operational knob 550 to the desired position, and continues the shower. The knob, and indeed the entire device of the present invention, is located within the immediate vicinity of the end use of the water, which may be a shower head, water faucet, spigot, or other watering device. Thus, accessing and operating the present invention is convenient for the end user.

It should be noted that the present invention will serve in many applications of water conservation outside the residential shower and bath. For example, the current invention could serve in a landscape watering system, to limit the amount of water usage. Hotels and restaurants may find application in the water conserving applications apparent in the current invention. Other examples wherein embodiments of the current invention may be employed include without limitation cooking, cleaning, washing dishes, lawn irrigation, flower watering, outdoor showering, and commercial food preparation.

Other applications not herein described will become obvious from inspection of the above specification and the attached drawings, and from experience drawn from the ease of use of the various embodiments of the current invention.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the claims herein presented.

I claim:

1. A device for controlling water flow, comprising:
a first housing for the main conduit of water flow, said conduit member comprising a first attachment means to removably connect to a supply conduit of a controllable water flow at one end of said main conduit member, and a second attachment means to removably connect to an outlet conduit for water flow at a second end of said main conduit member;
said conduit member having a bore formed at least part way therethrough for receiving water from the supply conduit;
a valve actuator mechanism, housed within a second housing;
a regulator valve disposed within said second housing, and capable of interacting within said bore of said main conduit member for control of water between full flow and no flow;
said regulator valve including a ball for slidable contact with the valve actuator mechanism;
whereby selective operation of the valve actuator mechanism within said second housing is effective to position the valve actuator and the regulator valve in a complementary relationship so as to maintain a desired quantity of water flow of water from the water flow control device to said outlet conduit.

2. A water flow control device as claimed in claim 1, further including a timer device for controlling the operation of said valve actuator mechanism.

3. A water flow control device as claimed in claim 1 wherein said first housing further comprises a second conduit member, said second conduit member in communication with said first conduit member so as to allow water flow from one conduit member to the other.

4. A water flow control device as claimed in claim 3, wherein the long axis of said second conduit member is positioned at a right angle to the long axis of said first conduit member.

5. A water flow control device as claimed in claim 3, wherein said regulator valve is capable of interacting within said bore of said main second conduit member for control of water between full flow and no flow.

6. A water flow control device as claimed in claim 3, wherein said regulator valve comprises a plate valve member, said plate valve member being capable when properly actuated of sealing off a conduit member, and thereby preventing water flow through said conduit member.

7. A water flow control device as claimed in claim 3, wherein said plate valve member, having a surface complementary to and at times in slidable contact with the interior of said second conduit member, and capable of sealing said conduit member and thereby blocking water flow through said conduit member.

8. A water flow control device as claimed in claim 3, wherein said device is capable of being fitted onto an existing water supply system.

9. A water flow control device as claimed in claim 3, wherein said device is resistant to pressure, and capable of conveying waters under pressure.

10. A water flow control device as claimed in claim 3, wherein said device is resistant to pressure, and capable of conveying waters under pressure sufficient to deliver water to end uses on the higher floors of a high-rise hotel.

11. A water flow control device as claimed in claim 3, wherein said device is resistant to pressure, and capable of conveying waters under pressure sufficient to deliver water to end uses on the higher floors of a cruise ship.

12. An energy saving device for controlling the flow of water, comprising:
a first housing for the main conduit of water flow, said conduit member comprising a first attachment means to removably connect to a supply conduit of a controllable water flow at one end of said main conduit member, and a second attachment means to removably connect to an outlet conduit for water flow at a second end of said main conduit member;
said conduit member having a first bore formed part way therethrough for receiving water from the supply conduit;
said conduit member having a second bore formed part way therethrough for delivering water to the outlet conduit, said second bore not in direct contact with said first bore;
a second conduit member, for conveying water from the first bore within the main conduit member to the second bore within the main conduit member;
a valve actuator mechanism, housed within a second housing;
a regulator valve disposed within said second housing, and capable of interacting within said bore of said second conduit member for control of water between full flow and no flow;
said regulator valve including a ball for slidable contact with the valve actuator mechanism;
a timer, housed within said second housing;
whereby selective operation of the valve actuator mechanism within said second housing is effective to position the valve actuator and the regulator valve in a complementary relationship so as to maintain a desired quantity of water flow of water from the water flow control device to said outlet conduit.
